(19) United States
(12) Patent Application Publication
(10) Pub. No.: US 2025/0039781 A1
(43) Pub. Date: Jan. 30, 2025

(54) WIRELESS COMMUNICATION APPARATUS, METHOD FOR CONTROLLING THE SAME, AND STORAGE MEDIUM

(71) Applicant: CANON KABUSHIKI KAISHA, Tokyo (JP)

(72) Inventor: TAKAFUMI NAKAJIMA, Tokyo (JP)

(21) Appl. No.: 18/890,554

(22) Filed: Sep. 19, 2024

Related U.S. Application Data
(63) Continuation of application No. PCT/JP2023/007962, filed on Mar. 3, 2023.

(30) Foreign Application Priority Data
Mar. 23, 2022 (JP) 2022-047585

(51) Int. Cl. H04W 48/20; H04W 48/16; H04W 84/12

(52) U.S. Cl. CPC H04W 48/20; H04W 48/16; H04W 84/12

(57) ABSTRACT

There is provided a wireless communication apparatus having a plurality of station functions and being connectable with a plurality of access points in parallel. The apparatus detects access points, and selects an access point to be connected with the wireless communication apparatus, from the detected plurality of access points. The apparatus performs control so that an access point having already been connected via a first station function is not selected as an access point to be connected via a second station function.

### Cross-Reference to Related Applications

This application is a Continuation of International Patent Application No. PCT/JP2023/007962, filed Mar. 3, 2023, which claims the benefit of Japanese Patent Application No. 2022-047585, filed Mar. 23, 2022, both of which are hereby incorporated by reference herein in their entirety.

### BACKGROUND OF THE INVENTION

### Field of the Invention

The present invention relates to a wireless communication apparatus, a method for controlling the wireless communication apparatus, and a storage medium.

### Background Art

The Institute of Electrical and Electronic Engineers (IEEE) 802.11 standard is known as a communication standard for Wireless Local Area Networks (WLANs). The Wi-Fi standard and the Wi-Fi Direct standard prescribed by Wi-Fi Alliance are also known as communication standards for WLANs.

Conventionally, there has been discussed a wireless communication apparatus conforming to the IEEE 802.11 standard and the Wi-Fi standard, capable of operating a station (STA) function and an access point (AP) function in parallel. The STA function enables the apparatus to connect with an external AP and participate in the network formed by the external AP. The AP function also enables the apparatus to connect with an external STA and make the external STA participate in the network formed by the apparatus itself. Likewise, there has been discussed a technique for operating a STA function and a Wi-Fi Direct function in parallel.

A system discussed in Patent Literature 1 can connect with an AP through the STA function and at the same time connect with a wireless communication apparatus conforming to the Wi-Fi Direct standard through the Wi-Fi Direct function.

### CITATION LIST

### Patent Literature

PTL 1: Japanese Patent Laid-Open No. 2014-225861

If one wireless communication apparatus is provided with a plurality of STA functions, the apparatus may be able to connect with a plurality of external APs at the same time. If such a wireless communication apparatus is configured to operate a plurality of STA functions in parallel in this way, connecting STA functions with different APs enables increasing the number of networks to be connected with the wireless communication apparatus. However, if different STA functions of the wireless communication apparatus are connected with the same AP, the number of networks to be connected with the wireless communication apparatus cannot be increased. For example, in a state where one STA function of the wireless communication apparatus has already been connected with an AP, when connecting the other STA function with a new AP, the user may incorrectly select the same AP as the AP having already been connected as the connection destination of the other STA function. If the wireless communication apparatus is connected with the same AP via a plurality of STA functions aiming to increase the number of networks to be connected, the number of networks to be connected with the wireless communication apparatus cannot be increased. In addition, to prevent the same AP as the AP having already been connected from being selected as the connection destination of the other STA function, the user needs to carefully perform operations, degrading the operability.

### SUMMARY OF THE INVENTION

In view of the above-described issue, the present invention is directed to improving operability when connecting a wireless communication apparatus having a plurality of station functions with an external access point.

A wireless communication apparatus having a plurality of station functions and being connectable with a plurality of access points in parallel includes a detection unit configured to detect access points, a selection unit configured to select an access point to be connected with the wireless communication apparatus, from the plurality of access points detected by the detection unit, and a control unit configured to perform control so that an access point having already been connected via a first station function is not selected as an access point to be connected via a second station function.

Further features of the present invention will become apparent from the following description of exemplary embodiments with reference to the attached drawings.

### BRIEF DESCRIPTION OF THE DRAWINGS

FIG. 1 illustrates a network configuration according to the present invention.

FIG. 2 illustrates a configuration of a printer 101.

FIG. 3 is a flowchart illustrating processing for setting the printer 101.

FIG. 4 is a flowchart illustrating processing for displaying an access point (AP) list

FIG. 5 illustrates a first example of a screen transition.

FIG. 6 illustrates a second example of a screen transition.

FIG. 7 illustrates a third example of a screen transition.

FIG. 8 illustrates a fourth example of a screen transition.

FIG. 9 illustrates a fifth example of a screen transition.

FIG. 10 illustrates a sixth example of a screen transition.

### DESCRIPTION OF THE EMBODIMENTS

Exemplary embodiments of the present invention will be described below with reference to the accompanying drawings. Configurations described in the following exemplary embodiments are to be considered as illustrative, and the present invention is not limited to illustrated configurations.

An example of a wireless Local Area Network (LAN) system conforming to the Institute of Electrical and Electronic Engineers (IEEE) 802.11 standard will be described below. The wireless LAN system may conform to Bluetooth®, Near Field Communication (NFC), Ultra Wide Band (UWB), Zigbee, Multi Band OFDM Alliance (MBOA), and other communication standards in addition to the IEEE 802.11 standard. UWB is an acronym of Ultra Wide Band, and MBOA is an acronym of Multi Band OFDM Alliance. OFDM is an acronym of Orthogonal Frequency Division Multiplexing. NFC is an acronym of Near Field Communication. UWB includes wireless Universal Serial Bus (USB) and wireless 1394. The following exemplary embodiments do not limit the present invention within the scope of the appended claims. Although a plurality of features is described in the exemplary embodiments, not all of the plurality of features is indispensable to the present invention, and the plurality of features may be arbitrarily combined. In the accompanying drawings, identical or similar components are assigned the same reference numerals, and duplicated descriptions thereof will be omitted.

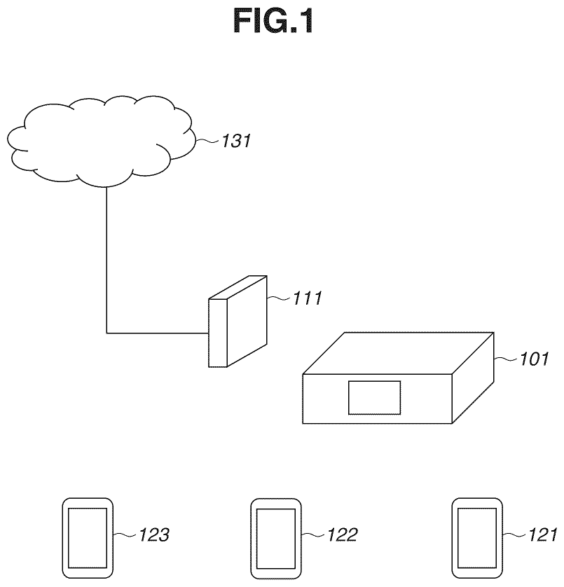

Although FIG. 1 illustrates a network configuration according to the present invention, the present invention is not limited thereto. The network may include a wireless communication apparatus having a plurality of station functions, and a plurality of different wireless communication apparatuses having an access point function connectable with the wireless communication apparatus.

Referring to FIG. 1, a printer 101 is a wireless communication apparatus having a plurally of STA functions. Examples of the printer 101 include a camera, personal computer (PC), television (TV), projector, Internet of Things (IoT) apparatus (smart home electric appliance), smart device (smartphone or tablet), and other wireless communication apparatuses having a plurally of station functions.

A wireless router 111 has an AP function. Smart devices 121, 122, and 123 have an AP function. The wireless router 111 and the smart devices 121, 122, and 123 have an AP function and are connectable as an AP with the STA. The Service Set Identifiers (SSIDs) of the networks configured by the wireless router 111 and the smart devices 121, 122, and 123 are “Office ap”, “My phone”, “Your phone”, and “His phone”, respectively. The wireless router 111 and the smart devices 121, 122, and 123 may be wireless communication apparatuses having an AP function, such as wireless routers, modems, smartphones, tablets, smart devices (smart watches), and personal computers (PCs). The printer 101 can selectively connect with the wireless router 111 and the smart devices 121, 122, and 123.

The network includes the Internet 131. The printer 101 may be connected with the Internet 131 via a cloud network or a public telephone network.

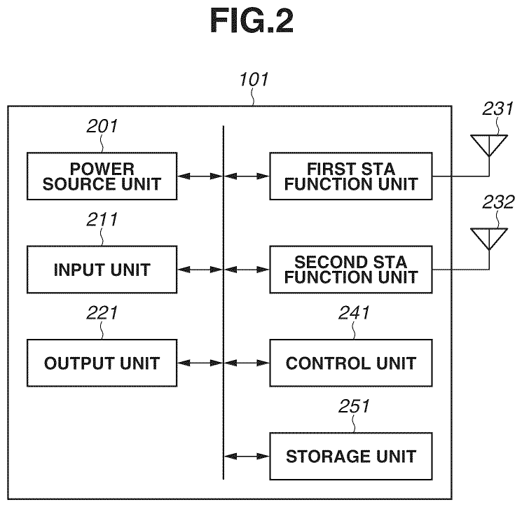

FIG. 2 illustrates a configuration of the printer 101.

The printer 101 includes a power source unit 201. The power source unit 201 supplies power to each hardware component. The power source unit 201 acquires, for example, power from an alternate current (AC) power source or a battery.

The printer 101 includes an input unit 211. The input unit 211 receives various operations from the user and includes, for example, operation buttons.

The printer 101 includes an output unit 221. The output unit 221 outputs various kinds of information to the user. Examples of outputs from the output unit 221 include light emitting diode (LED) display, screen display, an audio output with a speaker, and a vibration output. Both the input unit 211 and the output unit 221 may be implemented by one module as a display unit such as a touch panel. The input unit 211 and the output unit 221 do not need to be built into the printer 101, and a terminal different from the printer 101 may perform input and output operations. The following descriptions premise that a touch panel is used to perform input and output operations.

The printer 101 includes a first STA function unit 231 and a second STA function unit 232. The first STA function unit 231 and the second STA function unit 232 perform wireless LAN control and electric wave transmission and reception conforming to the IEEE 802.11 standard to connect with an AP. The printer 101 is configured to operate two different STA functions in parallel to establish connections with two different APs at the same time. The printer 101 may have three or more STA function units to enable parallel operations of desired number of STA functions. The STA function units included in the printer 101 may enable wireless communication through the Wi-Fi Direct function conforming to the Wi-Fi Direct standard. The Wi-Fi Direct standard defines a protocol for determining whether each wireless communication apparatus operates as a Group Owner (hereinafter referred to as a GO) or a Client. The execution of the protocol automatically determines that which one of the wireless communication apparatuses becomes a GO and the other becomes a Client. Then, the GO and the Client connect and communicate with each other.

The printer 101 includes a control unit 241. The control unit 241 includes a processor such as a Central Processing Unit (CPU) or a Micro Processing Unit (MPU) and controls the entire printer 101 by executing a program stored in a storage unit 251. Instead of the control unit 241 controlling the entire apparatus, a plurality of hardware components may share processing to control the entire apparatus.

The printer 101 includes the storage unit 251. The storage unit 251 includes memories such as a Random Access Memory (RAM) and a Read Only Memory (ROM), and stores programs for executing various kinds of processing to be described below and information about the APs connected with the STAs and information about the GO and the Client. The storage unit 251 may store pre-acquired various kinds of information including information required for the printer 101 to connect with other communication apparatuses via the STA function units.

Examples of the information required for connection include Service Set Identifiers (SSIDs), Basic Service Set Identifiers (BSSIDs), encryption information, and radio wave intensity information for the networks built by APs. The information required for connection may also include additional information included in a Beacon frame or Probe Response frame transmitted from an AP, information that can be acquired from the AP, and information that may possibly be used to connect with the AP.

The information required for connection may include the SSID, BSSID, encryption information, and radio wave intensity information for the network built by each wireless communication apparatus having the Wi-Fi Direct function. The information required for connection may also include additional information included in a Beacon frame and a Probe Response frame transmitted from each wireless communication apparatus having the Wi-Fi Direct function. The information required for connection may also include information that can be acquired from the wireless communication apparatus having the Wi-Fi Direct function and information required to or possibly used to connect with the wireless communication apparatus having the Wi-Fi Direct function.

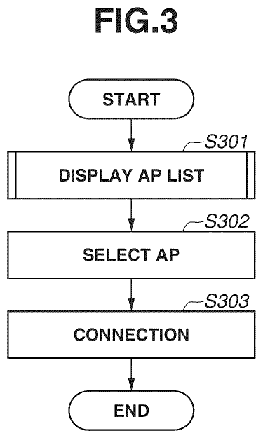

FIG. 3 is a flowchart illustrating processing for setting the printer 101. This setting processing is started when setting the connection destinations of the printer 101 using the STA function units. Examples of such cases include a case where the user operates the input unit 211 to select a setting menu for setting connection destinations with which the printer 101 is to be connected via the STA function units. When the setting processing is started, the control unit 241 searches for APs around the printer 101 and detects and acquires information about the surrounding APs. In step S301, the control unit 241 generates a list of APs based on the acquired AP information and displays the AP list. The AP list displayed in step S301 will be described below.

In step S302, after displaying the AP list, the printer 101 selects an AP to be connected via the STA function unit. This selection may be made based on an input from the user via the input unit 211 or on automatic selection by the control unit 241. In the AP selection processing in step S302, AP list display may be omitted if a user input is not used.

In step S303, the control unit 241 connects the printer 101 with the AP selected in the AP selection processing (S302), via an STA function unit of the printer 101.

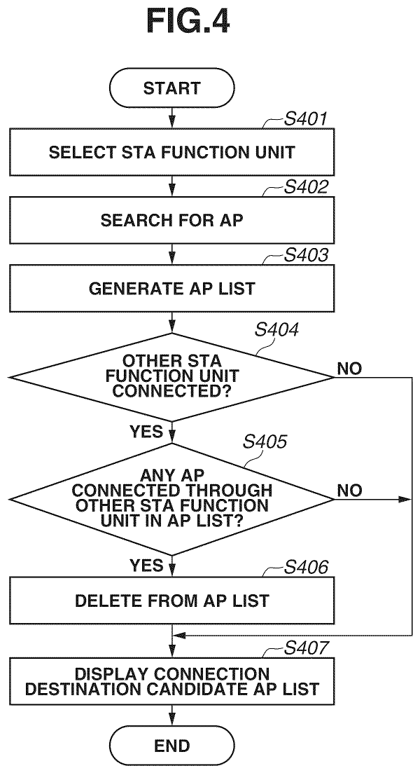

FIG. 4 is a flowchart illustrating details of the AP list display processing (S301). In step S401, the control unit 241 selects the STA function unit to be used to connect the printer 101 with the AP from a plurality of STA function units of the printer 101. This selection may be made based on an input from the user via the input unit 211 or on automatic selection by the control unit 241. The STA function unit to be used for the connection may be selected at a different timing. For example, in the STA function unit selection processing (S401), the control unit 241 determines which function is to be used for connection. The STA function unit to be used for connection may be selected after the AP selection processing (S302). In this case, the control unit 241 may identify the STA function unit having a higher radio wave intensity for the AP selected in the AP selection processing (S302).

In step S402, the control unit 241 searches for APs around the printer 101 connectable via the selected STA function unit, by using the STA function unit selected in the STA function unit selection processing (S401), and acquires information about the APs around the printer 101.

In step S403, the control unit 241 generates a list of connectable APs based on the information detected and acquired in the AP search processing (S402). The SSID and the BSSID of the network formed by each searched AP are often used for the AP list. The AP information may be optionally used.

After the AP list generation processing (S403), then in step S404, the control unit 241 determines whether the printer 101 has already been connected with an AP via an STA function unit different from the STA function unit selected in step S401. If the printer 101 has not been connected with an AP via an STA function unit different from the STA function unit selected in step S401, the processing proceeds to step S407. If the printer 101 has already been connected with an AP via an STA function unit different from the STA function unit selected in step S401, the processing proceeds to step S405.

In step S405, the control unit 241 determines whether the AP list generated in step S403 includes information about the AP with which the printer 101 has already been connected via an STA function unit different from the STA function selected in step S401. For example, the control unit 241 performs this determination by determining whether the AP list includes the SSID and BSSID as the information about the AP having already been connected. If the control unit 241 determines that the AP list includes the information about the AP with which the printer 101 has already been connected, the processing proceeds to step S406. If the printer 101 determines that the AP list does not include the information, the processing proceeds to step S407.

In step S406, the control unit 241 deletes from the AP list the information about the AP with which the printer 101 has already been connected via an STA function unit. Then, the AP list serves as a list of connection destination AP candidates. Then, the processing proceeds to step $407.

If the control unit 241 determines that an STA function unit different from the STA function selected in step S401 is not connected with an AP in step S404, the AP list generated in step S403 serves as a list of connection destination AP candidates. In step S405, if the AP list includes no information about the AP with which the other STA function unit has been connected, the AP list generated in step S403 serves as a list of connection destination AP candidates.

In step S407, the control unit 241 displays a list of connection destination AP candidates on the output unit 221. Then, the processing exits the flowchart of the AP list display processing. A list of connection destination AP candidates is formed by deleting the information about the AP having already been connected with the STA function unit in the printer 101, from the information about the APs detected and acquired in step S402. Instead of deleting the information about the AP having already been connected, in step S407, the control unit 241 may display the information about the AP with which the printer 101 has already been connected via an STA function unit, so that the user can recognize the connection. For example, the control unit 241 may display the information about the AP having already been connected in a gray-out state or display the AP information together with an indication of the connection. The control unit 241 may display the information about the AP having already been connected, in a disabled state. If the control unit 241 displays the information about the AP with which the printer 101 has already been connected in this way in step S407, the processing may skip the processing in step S406. In step S302, based on the AP information selected by a user input via the input unit 211 or by the control unit 241 from the displayed AP list, the control unit 241 selects the connection destination AP of the printer 101 via the STA function unit selected in step S401. In step S303, the control unit 241 performs processing for connecting the printer 101 via the STA function unit selected in step S401 with the AP selected in step S302. In the AP list display processing (S407), if a user input is not accepted in the AP selection processing (S302), a user input may be omitted.

By removing the information about the AP having already been connected from the AP list in this way, the connected AP can be prevented from being selected as the connection destination AP of the wireless communication apparatus via the selected STA function unit. In addition, by displaying the information about the connected AP so that the user can recognize the connection, unintended AP selection can be prevented.

### First Operation Example

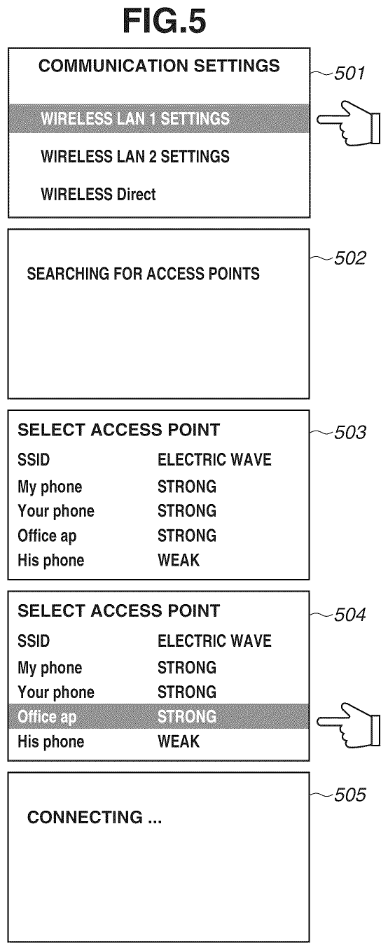

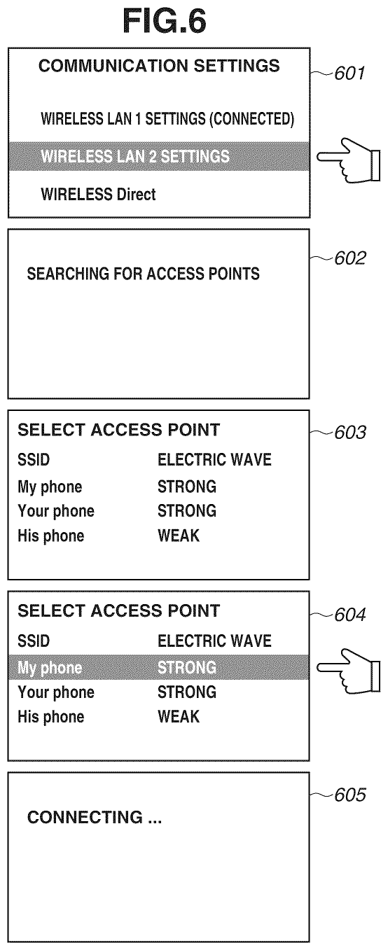

A first operation example of the present invention will be described below. FIGS. 5 and 6 illustrate examples of screen transitions of communication settings according to the present operation example. However, the present invention is not limited thereto. The present operation example will be described below centering on an example where, when connecting the printer 101 with an AP via the second STA function unit 232, the information about the AP having already been connected via the first STA function unit 231 is deleted from the AP list before the AP list is presented to the user. Examples of screen transitions will also be described below.

FIG. 5 illustrates a first example of a screen transition. A screen 501 appears when the user operates the input unit 211 to select a “Communication Settings” menu including some setting menus. At this timing, the control unit 241 may start the flowchart for AP list generation. According to the present operation example, the printer 101 is assumed to have been connected with none of the wireless router 111, and the smart devices 121, 122, and 123.

The “Communication Settings” screen according to the first example of a screen transition includes setting menus “Wireless LAN1 Settings”, “Wireless LAN2 Settings”, and “Wireless Direct”. In the “Communication Settings” screen, the user selects an STA function unit in step S401. According to the present operation example, “Wireless LAN1 Settings” is used to make settings for the wireless LAN communication via the first STA function unit 231. “Wireless LAN2 Settings” is used to make settings for the wireless LAN communication via the second STA function unit 232. “Wireless Direct” is used to make settings for the wireless LAN communication through the Wi-Fi Direct function via the second STA function unit 232.

The “Communication Settings” screen is not limited thereto. The user may firstly select which STA function unit is to be used and then select which function is to be used with the selected STA function unit (whether the Wi-Fi Direct function is to be executed). Conversely, the user may firstly select which function is to be used (whether the Wi-Fi Direct function is to be executed) and then select which STA function unit is to be used. Further, like the present operation example, the user may select the STA function unit and the function to be used, through a single selection operation. According to the present operation example, the user selects “Wireless LAN1 Settings” in the screen 501.

A screen 502 appears when the control unit 241 is searching for APs connectable via the first STA function unit 231 selected in the screen 501.

A screen 503 is a “Select Access Point” screen appearing after the screen 502. The screen 503 displays the AP list generated in the flowchart to generate a list of connection destination AP candidates illustrated in FIG. 4. According to the present operation example, the AP list displays the SSID and the radio wave intensities of the wireless network built by the AP functions of the wireless router 111 and the smart devices 121, 122, and 123. The display format of the AP list is not limited thereto. For example, the AP list displays the information in descending order of the radio wave intensity or in ascending order of distance from the selected STA function unit.

A screen 504 appears when the user is operating the input unit 211 to select the wireless router 111.

A screen 505 is displayed during the connection processing after the screen 504. According to the present operation example, in the screen 505, the control unit 241 performs processing for connecting the printer 101 with the wireless router 111 via the first STA function unit 231. When connecting the printer 101 to an AP, the user needs to input a password required for encryption depending on the encryption method of the wireless LAN set in the AP. However, the password input operation is omitted according to the present operation example. After the user selects a connection destination AP in the screen 504, the control unit 241 may display a password input screen and prompt the user to input a password.

FIG. 5 illustrates an example of a screen transition. The screen 501 may not be displayed if a user selection is not accepted in the selection of an STA function unit and function. The screens 502 and 505 appear during each piece of processing. These screens may be displayed together with other screens or in a different form, or may not be displayed. Further, instead of displaying the screens 502 and 505 during each piece of processing, only the completion of each piece of processing may be displayed. However, the screen display is not limited thereto.

FIG. 6 illustrates a second example of a screen transition. The screen transition in FIG. 6 is an example of a screen transition set in the “Communication Settings” screen after the screen transition in FIG. 5 is made. More specifically, the printer 101 is assumed to have been connected with the wireless router 111 via the first STA function unit 231.

A screen 601 is a “Communication Settings” screen on which the user performs an input operation through the input unit 211. Since the printer 101 has already been connected with the wireless router 111 via the first STA function unit 231, “Wireless LAN1 Settings” may display the connection. The information may be displayed with a text, or an identifiable symbol or color. The screen 601 may include the information about the AP having already been connected, so that the user can recognize the connection. For example, the display may include the SSID “Office ap” as the AP information for the wireless router 111. For “Wireless LAN2 Settings” and “Wireless Direct”, the information about the connection is not displayed since the printer 101 is not connected with the AP via the second STA function unit 232. In this case, the display may include only the unconnected state to distinguish between the connected and unconnected states.

According to the present operation example, the user selects “Wireless LAN2 Settings” in the screen 601.

A screen 602 appears when the control unit 241 is searching for APs connectable via the second STA function unit 232 selected in the screen 601.

A screen 603 is a “Select Access Point” screen appearing after the screen 602. The screen 603 displays a list of connection destination AP candidates via the second STA function unit 232 selected in the screen 601. When displaying the AP list in the screens 601 to 603, the control unit 241 executes the flowchart for the AP list generation illustrated in FIG. 4. The wireless router 111 is assumed to have been found as an AP connectable via the second STA function unit 232 in step S402. More specifically, at the time of AP list generation in step S404, the AP list includes the SSID “Office ap” as information about the wireless router 111. The printer 101 has already been connected with the wireless router 111 via the first STA function unit 231. Therefore, according to the flowchart for the AP list generation processing illustrated in FIG. 4, the control unit 241 deletes “Office ap” as information about the AP having already been connected via the first STA function unit 231 from the AP list indicating APs connectable via the second STA function unit 232. The screen 603 displays a list of connection destination AP candidates as a result of the deletion. More specifically, the screen 603 displays information about “My phone”, “Your phone”, and “His phone” but does not display “Office ap”.

A screen 604 appears when the user is operating the input unit 211 to select “My phone” as information about the smart device 121.

A screen 605 appears during the connection processing after the screen 604. In the screen 605, the control unit 241 performs processing for connecting the printer 101 with the smart device 121 via the second STA function unit 232.

In the above-described case, the control unit 241 deletes the information about the wireless router 111 having already been connected via the first STA function unit 231 from the connection destination AP list when connecting the printer 101 with the AP via the second STA function unit 232, and then displays the AP list. This enables preventing the wireless router 111 having already been connected via the first STA function unit 231 from being selected as the connection destination of the printer 101 via the second STA function unit 232. This enables preventing duplicated establishment of two different communication links via the first STA function unit 231 and the second STA function unit 232 for wireless router 111.

### Second Operation Example

The first operation example has been described above centering on communication settings of the second STA function unit 232 when the printer 101 has already been connected via the first STA function unit 231, as communication settings of the first STA function unit 231 and the second STA function unit 232. The first operation example has been described above centering on an example where the information about the AP having already been connected via the first STA function unit 231 is deleted from the AP list of the second STA function unit 232.

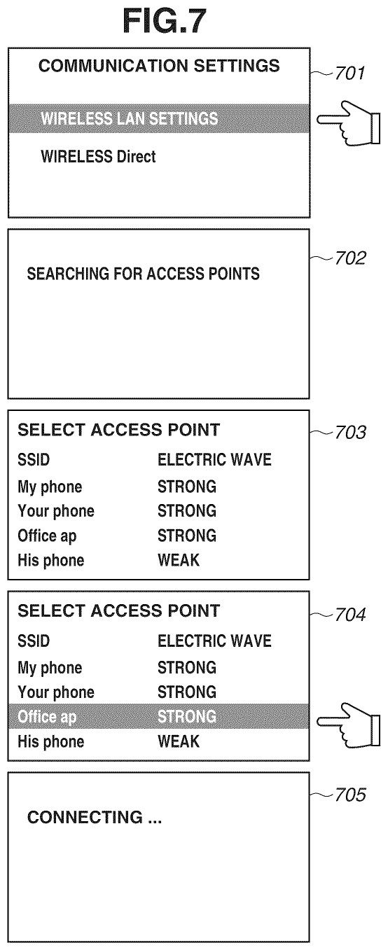

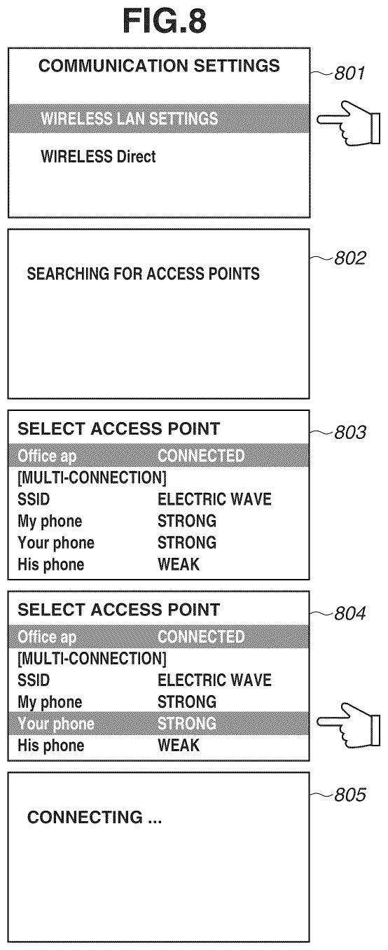

A second operation example of the present invention will be described below. FIGS. 7 and 8 illustrate examples of screen transitions of communication settings according to the present operation example. These examples are different from the screen transitions in FIGS. 5 and 6 according to the first operation example in that only the communication function to be used can be selected. The present operation example is different from the first operation example in that step S406 is not executed and that the AP list displays the information about the AP with which the printer 101 has already been connected, so that the user can identify the connection. The present operation example will be described below centering on an example where, when connecting the printer 101 via the second STA function unit 232, the control unit 241 presents the AP list to the user so that the user can identify the AP having already been connected via the first STA function unit 231. Examples of screen transitions according to the present operation example are not limited to the screen transitions in FIGS. 7 and 8, like the first operation example.

FIG. 7 illustrates a third example of a screen transition.

A screen 701 is a “Communication Settings” screen on which the user performs an input operation through the input unit 211. The “Communication Settings” screen includes setting menus “Wireless LAN Settings” and “Wireless Direct”. According to the present operation example, “Wireless LAN Settings” is used to make settings for the wireless LAN communication via the first STA function unit 231 and the second STA function unit 232. “Wireless Direct” is used to make settings for the Wi-Fi Direct communication via the second STA function unit 232, like the first operation example. According to the present exemplary embodiment, the user selects “Wireless LAN Settings” in the screen 701.

A screen 702 appears when the control unit 241 is searching for connectable APs around the printer 101. When searching for connectable APs around the printer 101, the control unit 241 searches for APs via the first STA function unit 231 according to the present operation example. However, the present invention is not limited thereto. The control unit 241 may perform processing for searching for APs via the second STA function unit 232. If either one STA function unit has already been connected with an AP, the control unit 241 may search for APs via the other STA function unit in the unconnected state. Alternatively, the control unit 241 may search for APs via both the first STA function unit 231 and the second STA function unit 232 in the unconnected state. If the same AP is found, the control unit 241 may register duplicate APs as one AP in the AP list, thus combining both search results to generate an AP list.

A screen 703 is a “Select Access Point” screen appearing after the screen 702. The screen 703 displays a list of connection destination AP candidates searched. When displaying the AP list in the screens 701 to 703, the control unit 241 executes the flowchart of the AP list generation processing illustrated in FIG. 4, with step $406 skipped. According to the present operation example, the AP list displays the SSID and the radio wave intensities of the network built by the wireless router 111 and the smart devices 121, 122, and 123.

A screen 704 appears when the user is operating the input unit 211 to select the wireless router 111.

A screen 705 appears during the connection processing after the screen 704. In the screen 705, the control unit 241 performs processing for connecting the printer 101 with the wireless router 111. According to the present operation example, the control unit 241 performs processing for connecting the printer 101 with the wireless router 111 via the first STA function unit 231 having searched for connectable APs in the screen 702.

FIG. 8 illustrates a fourth example of a screen transition. The screen transition in FIG. 7 is an example of a screen transition set in the “Communication Settings” screen after the screen transition in FIG. 7 is made. More specifically, the printer 101 is assumed to have been connected with the wireless router 111 via the first STA function unit 231.

A screen 801 is a “Communication Settings” screen on which the user performs an input operation through the input unit 211. The user selects “Wireless LAN Settings” in the screen 801.

A screen 802 appears when the control unit 241 is searching for connectable APs. According to the present operation example, since the printer 101 has already been connected with an AP via the first STA function unit 231, the control unit 241 searches for APs connectable via the second STA function unit 232.

A screen 803 is a “Select Access Point” screen appearing after the screen 802. The screen 803 displays a list of connection destination AP candidates. In this case, the printer 101 has already been connected with the wireless router 111 via the first STA function unit 231. Therefore, the screen 803 displays the information about the wireless router 111 including “Office ap” as the SSID and “Connected”, so that the user can recognize that the printer 101 has already been connected with the wireless router 111. The information about the connection may be displayed with a text, or an identifiable symbol or color. The screen 803 may include the information about the wireless router 111 having already been connected, so that the user can recognize the connection. In addition, the screen 803 displays information about unconnected APs as “Multi-connection”. A list of connection destination AP candidates displays “Office ap”, “My phone”, “Your phone”, and “His phone”. According to the present operation example, the screen 803 displays the SSID “Office ap” as the information about the wireless router 111 having already been connected via the first STA function unit 231 determined in step S405, in a disabled state. If the information about the AP having already been connected may be displayed in a disabled state, the information about the AP having already been connected and the information about other APs may be displayed without separation as “Multi-connection”.

A screen 804 appears when the user is operating the input unit 211 to select the smart device 122.

A screen 805 appears during the connection processing after the screen 804. In the screen 805, the control unit 241 performs processing for connecting the printer 101 with the smart device 122 via the second STA function unit 232 based on the selection in step 804.

In the above-described case, the control unit 241 displays a list of connection destination AP candidates including the information about the AP having already been connected, so that the user can recognize the connection. This enables preventing the AP having already been connected via the other STA station unit from being unintendedly selected as the connection destination of the STA function unit.

Although, according to the present operation example, a communication method is selected in communication setting and then the STA function unit to be used is automatically selected, the present invention is not limited thereto. For example, after a communication method is set in communication setting, the STA function unit to be used may not be selected. In this case, the control unit 241 may perform AP search by using an unconnected STA function unit capable of performing the selected communication method. Then, the control unit 241 generates an AP list based on the search result. Then, the control unit 241 may determine whether the information about the connected AP is included in the AP list in step S405, and then display the AP list so that the user can recognize the connection. Then, the control unit 241 may select the STA function unit based on the AP selected at the time of AP selection in step S303.

According to the present operation example, the control unit 241 displays the AP having already been connected, so that the user cannot select the connected AP. However, the control unit 241 does not need to disable the selection of the AP but may enable the selection of the AP. For example, the control unit 241 may display the AP having already been connected, so that the user can recognize the connection. Even in this case, as in the present operation example, the user is allowed to recognize the AP having already been connected and select the connection destination AP. This enables preventing the AP having already been connected via the other STA station unit from being unintendedly selected as the connection destination of the STA function unit.

### Third Operation Example

The first and second operation examples have been described above centering on an example where the first STA function unit 231 and the second STA function unit 232 operate on the STA function.

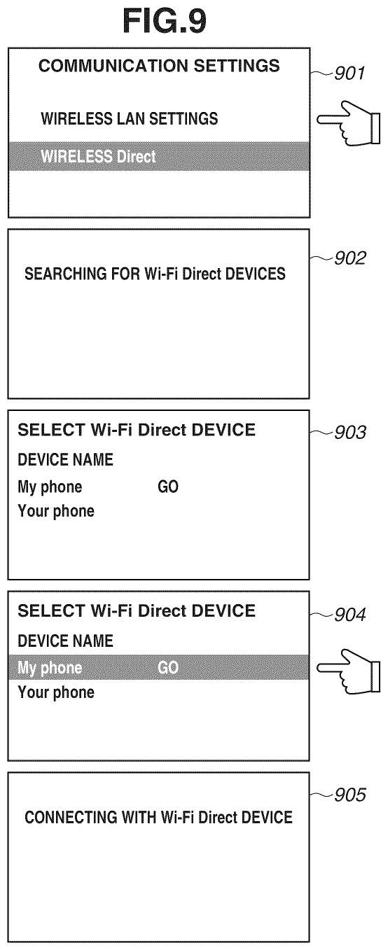

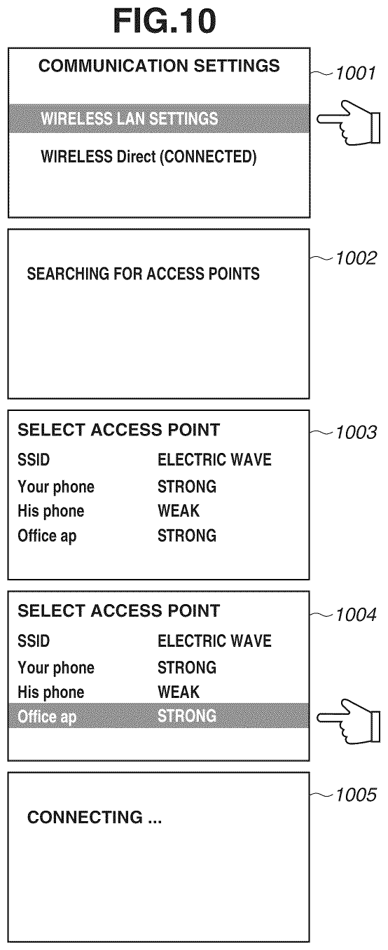

A third operation example of the present invention will be described below. FIGS. 9 and 10 illustrate examples of screen transitions of communication setting according to the present example. The present operation example is different from the first and second operation examples in that the second STA function unit 232 uses the Wi-Fi Direct function.

According to the present operation example, the smart devices 121 and 122 can also operate on the Wi-Fi Direct function. The smart device 121 has already been operating as a GO to configure a network by having the SSID “DIRECT-AB-My phone”.

FIG. 9 illustrates a fifth example of a screen transition. A screen 901 is a “Communication Settings” screen on which the user operates the input unit 211 to input information. According to the present operation example, the “Communication Settings” screen includes setting menus “Wireless LAN Settings” and “Wireless Direct” like the second operation example. The setting menus may be similar to the setting menus of the first operation example. According to the present operation example, “Wireless LAN Settings” is used to make settings for the wireless LAN communication through the STA function via the first STA function unit 231 or the second STA function unit 232. “Wireless Direct” is used to make settings for the wireless LAN communication through the Wi-Fi Direct function via the second STA function unit 232.

In a screen 901, the user selects “Wireless Direct”. The printer 101 is connected with none of the wireless router 111, and the smart devices 121, 122, and 123.

A screen 902 appears when the control unit 241 is searching for Wi-Fi Direct functions around the printer 101 via the second STA function unit 232.

A screen 903 is a “Select Wi-Fi Direct Device” screen appearing after the screen 902. The screen 903 displays a list of wireless communication apparatuses having the Wi-Fi Direct function as connection destination candidates.

According to the present operation example, since the control unit 241 searches for Wi-Fi Direct functions in the AP search processing (S402), the control unit 241 generates a list of connection destination candidates by using the information about the Wi-Fi Direct function in step S403. According to the present operation example, since the Wi-Fi Direct function is used, the control unit 241 determines whether the list includes the information about the Wi-Fi Direct function with which the printer 101 has already been connected via an STA function unit in step S405.

In the screen 903, the AP list displays the smart devices 121 and 122. The screen 903 displays the device name for Wi-Fi Direct set in each smart device and whether the device is operating as a GO. The display format is not limited thereto but may optionally include the information about the Wi-Fi Direct function.

A screen 904 appears when the user is operating the input unit 211 to select the smart device 121. A screen 905 appears during the connection processing after the screen 904. In the screen 905, the control unit 241 performs processing for connecting the printer 101 with the smart device 121 via the Wi-Fi Direct function of the second STA function unit 232.

FIG. 10 illustrates a sixth example of a screen transition. The screen transition in FIG. 10 is an example of a screen transition set in the “Communication Settings” screen after the screen transition in FIG. 9 is made. More specifically, the printer 101 is assumed to operate the second STA function unit 232 as a Client of Wi-Fi Direct and have already been connected with the smart device 121 operating as a GO.

A screen 1001 is a “Communication Settings” screen on which the user performs an input operation through the input unit 211. Since the printer 101 has already been connected with the smart device 121 via the Wi-Fi Direct function of the second STA function unit 232, the connection may be displayed for “Wireless Direct”. In the screen 1001, the user selects “Wireless LAN Settings”.

A screen 1002 appears when the control unit 241 is searching for connectable APs around the printer 101.

A screen 1003 is a “Select Access Point” screen appearing after the screen 1002. The screen 1003 displays a list of connection destination AP candidates.

When displaying the AP list in the screen 1003, the control unit 241 executes the flowchart for the AP list generation illustrated in FIG. 4.

In this case, the AP list includes the SSID “DIRECT-AB-My phone” of the network built by the smart device 121 as a GO at the time of AP list generation in step S403. If AP search is made by the STA function, the GO is found like a normal AP. Therefore, the AP list also includes the information about the GO function of the smart device 121 that functions as a GO. The printer 101 has already been connected with the smart device 121 via the Wi-Fi Direct function of the second STA function unit 232. Therefore, according to the present operation example, the control unit 241 deletes the SSID “DIRECT-AB-My phone” of the network built by the smart device 121 as a GO from the AP list in step S406.

The resultant list is a list of connection destination AP candidates. The screen 1003 displays the information about “Your phone”, “His phone”, and “Office ap” but does not display “DIRECT-AB-My phone”.

A screen 1004 appears when the user is operating the input unit 211 to select the wireless router 111.

A screen 1005 appears during the connection processing after the screen 1004. In the screen 1005, the control unit 241 performs processing for connecting the printer 101 with the wireless router 111 via the first STA function unit 231.

In the above-described case, the AP with which the first STA function unit 231 is to be connected is selected in a state where the second STA function unit 232 as a Client has already been connected with the GO via the Wi-Fi Direct function. The control unit 241 displays the list of connection destination AP candidates to be connected via the first STA function unit 231 without including the information about the AP as a GO with which the second STA function unit 232 has already been connected as a Client of the Wi-Fi Direct function. This enables preventing the user from incorrectly selecting the smart device 121 as a GO having already been connected via the second STA function unit 232, as the connection destination via the first STA function unit 231. This enables preventing duplicated establishment of two different communication links via the first STA function unit 231 and the second STA function unit 232 for the smart device 121.

### Fourth Operation Example

The third operation example has been described above centering on an example where, in a case where the printer 101 has already been connected with the GO via the Wi-Fi Direct function of one STA function unit, the printer 101 is connected with the GO via the other STA function unit.

A fourth operation example of the present invention will be described below. The present operation example is different from the first, the second, and the third operation examples in that both the first STA function unit 231 and the second STA function unit 232 connect with the GO, as a Client of the Wi-Fi Direct function. The present operation example will be described below centering on a case where both the first STA function unit 231 and the second STA function unit 232 connect with the GO via the Wi-Fi Direct function.

According to the present operation example, the printer 101 is assumed to have already been connected with the smart device 121 operating as a GO via the Client of the Wi-Fi Direct function of the first STA function unit 231. In this state, the control unit 241 performs communication settings for the second STA function unit 232. In step S401, the Wi-Fi Direct function is selected. The control unit 241 searches for wireless communication apparatuses operating on the Wi-Fi Direct function connectable via the second STA function unit, and generates an AP list based on the information about the Wi-Fi Direct function as a search result. At this timing, since the printer 101 has already been connected with the smart device 121 operating as a GO via the first STA function unit 231, the control unit 241 deletes the information about the smart device 121 from the generated AP list in step S406. The control unit 241 can remove the information about the GO having already been connected, from the AP list even in connection via the Wi-Fi Direct function.

The present invention is applicable to prevent connection not intended by the user not only in connection through the STA function but also in connection of a plurality of STA function units via the Wi-Fi Direct function.

### Other Operation Examples

In each of the above-described operation examples, when connecting the printer 101 via one STA station unit, the printer 101 has already been connected via the other STA function unit. However, the present invention is not limited thereto. For example, the control unit 241 determines whether an AP in the generated AP list is to possibly be connected via the other STA station unit, and does not display the information about the AP to possibly be connected in the AP list like the first operation example. In addition, the control unit 241 may display the AP list so that the AP to possibly be connected is displayed but cannot be selected, like second operation example.

An AP list when connecting the printer 101 via the second STA function unit 232 like the first operation example will be described below. For example, the control unit 241 stores the information about the AP with which the first STA function unit 231 has been once connected, as connection history information. When making connection settings via the second STA function unit 232, if the AP list generated in step S403 includes the information about an AP included in connection history information for connections via the first STA function unit 231, the control unit 241 may delete the information about the AP from the AP list. Like the second operation example, the control unit 241 may display the AP information so that the user can recognize the possibility of connection.

The present invention is also applicable to a case where the control unit 241 receives information required for the printer 101 to be connected with a predetermined AP through Wi-Fi Protected Setup (WPS) via the first STA function unit 231. The wireless LAN parameter is information about the AP to possibly be connected via the first STA function unit 231. When connecting the printer 101 via the second STA function unit 232, if the AP list includes the information about the AP corresponding to the wireless LAN parameter received through WPS via the first STA function unit 231, the control unit 241 deletes the information about the AP from the AP list. Alternatively, the control unit 241 displays the information in a disabled state.

If a connection with the wireless router 111 via the first STA function unit 231 is disconnected during display of a list of connection destination APs via the second STA function unit 232 in a state where the printer 101 is connected with the wireless router 111 via the first STA function unit 231. Upon occurrence of a disconnection, the control unit 241 may include the information about the wireless router 111 in the AP list to display the information, or change the display of the existing connection. Determining the connection and disconnection states of the other STA station unit and controlling the display state in the AP list in this way enables providing the user with flexible connection settings.

Although, in the above-described operation examples, the connection destination AP is selected from the AP list, the present invention is not limited thereto. For example, the control unit 241 may accept a manually input parameter through the input unit 211 in setting the connection destination AP via the second STA function unit 232. In this case, if the input SSID is the same as the SSID of the AP having already been connected or to possibly be connected via the first STA function unit 231, the control unit 241 may display a warning to the user. Alternatively, the control unit 241 may notify the user that the printer 101 has already been connected via the first STA function unit 231. The printer 101 needs to be prevented from being connected with the same AP via a plurality of STA function units in a user operation. However, the present invention is not limited thereto.

Operation examples have been described above based on the connection settings of one STA function unit in a case where the printer 101 has already been connected via the other STA station unit, the present invention is not limited thereto. For example, in a case where the printer 101 has already been connected via the first STA function unit, the control unit 241 may perform the connection settings of the first STA function unit to change the connection destination via the first STA function unit. In this case, the information about the AP having already been connected via the first STA function unit is deleted from the AP list in step S406. This enables preventing the AP having already been connected from being selected again when changing the connection destination of the STA function unit.

Although operation examples have been described above centering on a case where the printer 101 has two different STA function units, the present invention is not limited thereto. The present invention is also applicable to a wireless communication apparatus having three or more STA function units and being capable of connecting with three or more APs in parallel.

Although a case of using the Wi-Fi Direct function has been described above, the present invention is not limited thereto. The control unit 241 may determine the AP list generation processing in FIG. 4 targeting the wireless LAN network with which each STA function unit can be connected.

Although the present invention has been described above centering on a case where communication between apparatuses is performed through the wireless LAN communication conforming to the IEEE 802.11 standard, the present invention is not limited thereto. For example, a storage medium storing a program code of software for implementing the functions is supplied to a system or apparatus, and a computer (or CPU or micro processing unit (MPU)) of the system or apparatus reads the program code stored in the storage medium and then executes the program code. In this case, the program code itself read from the storage medium implements the functions of the above-described exemplary embodiments, and the storage medium storing the program code is included in the present invention.

Examples of recording media for supplying the program code include a flexible disk, a hard disk, an optical disk, a magneto-optical disk, a compact disc read only memory (CD-ROM), a compact disc recordable (CD-R), a magnetic tape, a nonvolatile memory card, a read only memory (ROM), and a digital versatile disc (DVD).

The functions of the above-described exemplary embodiments may be implemented not only when the computer executes the read program code but also when the operating system (OS) operating on the computer executes part or whole of actual processing based on instructions of the program code. OS is an abbreviation for Operating System.

Further, the program code read from the storage medium is written to a memory included in a function expansion board inserted into the computer or a function expansion unit connected to the computer. The CPU included in the function expansion board or the function expansion unit may implement the above-described functions by executing part or whole of actual processing based on instructions of the program code.

The present invention is not limited to the above embodiments and various changes and modifications can be made within the spirit and scope of the present invention. Therefore, to apprise the public of the scope of the present invention, the following claims are made.

This application claims priority from Japanese Patent Applications No. 2022-047585 filed Mar. 23, 2022, which is hereby incorporated by reference herein.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

The present invention makes it possible to improve operability when connecting a wireless communication apparatus having a plurality of station functions with an external access point.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. A wireless communication apparatus having a plurality of station functions and being connectable with a plurality of access points in parallel, the apparatus comprising:
a detection unit configured to detect access points;
a selection unit configured to select an access point to be connected with the wireless communication apparatus, from the plurality of access points detected by the detection unit; and
a control unit configured to perform control so that an access point having already been connected via a first station function is not selected by the selection unit as an access point to be connected via a second station function.

2. The wireless communication apparatus of claim 1, further comprising a display unit configured to display the access points detected by the detection unit, wherein, out of the plurality of access points detected by the detection unit, the display unit displays access points excluding the access point having already been connected via the first station function.

3. The wireless communication apparatus of claim 1, further comprising a display unit configured to display the access points detected by the detection unit, wherein the display unit displays the plurality of access points detected by the detection unit so that the access points having already been connected via the first station function is not selected.

4. The wireless communication apparatus according to claim 1, wherein a display unit identifiably displays the access point having already been connected via the first station function.

5. The wireless communication apparatus according to claim 1, further comprising a determination unit configured to determine whether the plurality of access points detected by the detection unit includes the access point having already been connected via the first station function, wherein the determination unit performs the determination by using information required to be connected with an access point.

6. The wireless communication apparatus according to claim 5, wherein the information required to be connected is a Service Set Identifier (SSID) and/or a Basic Service Set Identifier (BSSID) of a network built by an access point.

7. The wireless communication apparatus according to claim 1, wherein a first access point is an access point operating as a Group Owner prescribed in a Wi-Fi Direct standard.

8. The wireless communication apparatus according to claim 1, wherein the first and second station functions are connected with access points through a protocol conforming to an Institute of Electrical and Electronic Engineers (IEEE) 802.11 standard.

9. The wireless communication apparatus according to claim 1, wherein the first and second station functions are capable of executing wireless communication conforming to a Wi-Fi Direct standard.

10. A method for controlling a wireless communication apparatus having a plurality of station functions and being connectable with a plurality of access points in parallel, the method comprising:
detecting access points;
selecting an access point to be connected with the wireless communication apparatus, from the plurality of access points detected in the detection; and
performing control so that an access point having already been connected via a first station function is not selected in the selecting as an access point to be connected via a second station function.

11. A non-transitory computer-readable storage medium storing a program for causing a computer to execute processing comprising:
detecting access points;
selecting an access point to be connected with the wireless communication apparatus, from the plurality of access points detected in the detection; and
performing control so that an access point having already been connected via a first station function is not selected in the selecting as an access point to be connected via a second station function.
